(19) United States
(12) Patent Application Publication
(10) Pub. No.: US 2021/0325426 A1
(43) Pub. Date: Oct. 21, 2021

(54) BALL BEHAVIOR ANALYSIS APPARATUS

(71) Applicant: SUMITOMO RUBBER INDUSTRIES, LTD., Hyogo (JP)

(72) Inventors: Masahide ONUKI, Hyogo (JP); Kuniyasu HORIUCHI, Hyogo (JP); Junya TSUTSUMI, Tokyo (JP); Jiro MORI, Tokyo (JP); Tsuyoshi ITO, Tokyo (JP); Masanobu YOSHIDA, Tokyo (JP)

(73) Assignee: SUMITOMO RUBBER INDUSTRIES, LTD., Hyogo (JP)

(21) Appl. No.: 17/231,518

(22) Filed: Apr. 15, 2021

(30) Foreign Application Priority Data
Apr. 17, 2020 (JP) 2020-074047

(51) Int. Cl. G01P 15/18; A63B 43/00; A63B 37/00; A63B 24/00

(52) U.S. Cl. CPC G01P 15/18; A63B 43/004; A63B 2102/18; A63B 24/0021; A63B 2220/44; A63B 37/007

(57) ABSTRACT

Provided is an analysis apparatus for analyzing a behavior of a ball that has a center of gravity and in which an acceleration sensor is installed at a position shifted from the center of gravity by a predetermined shift amount, the analysis apparatus including a control unit configured to derive a centrifugal acceleration that is applied to the acceleration sensor, based on acceleration data that is output by the acceleration sensor, and derive at least one of a direction of a rotation axis and a rotation speed of a spin of the ball, based on the predetermined shift amount and the centrifugal acceleration.

### CROSS REFERENCE TO RELATED APPLICATIONS

This application claims a priority to Japanese Patent Application No. 2020-074047 filed on Apr. 17, 2020, which is hereby incorporated by reference in its entirety.

### FIELD OF INVENTION

The present invention relates to an analysis apparatus, method, and program that analyze the behavior of a ball such as a golf ball, a baseball ball, and a tennis ball, a ball that is suitable for analyzing a behavior thereof, and a measurement method for measuring a position of an acceleration sensor installed in a ball.

### BACKGROUND

Balls in which a sensor such as an acceleration sensor or an angular velocity sensor is installed are conventionally known. With such balls, the behavior of the balls can be analyzed based on data output by the sensor while the ball is in motion. For example, JP 2012-58066A discloses a method for estimating a rotation speed of a ball based on acceleration data output by an acceleration sensor installed in the ball.

JP 2012-58066A is an example of related art.

However, in JP 2012-58066A, the acceleration data is subjected to a continuous wavelet transformation, and the rotation speed of the ball is estimated from the temporal change in amplitude values of a frequency, and thus the calculation load is heavy, and there is room for improvement. Furthermore, there is room for improvement in terms of accuracy as well. With regard to a technique for analyzing the behavior of balls, various ingenuity is required.

An object of the present invention is to provide an analysis apparatus, method, and program, and a ball that are suitable for analyzing a behavior of the ball. Furthermore, another object of the present invention is to provide a measurement method for measuring a position of an acceleration sensor installed in a ball. Furthermore, another object of the present invention is to provide a ball whose rotation axis can be stabilized.

### SUMMARY OF INVENTION

An analysis apparatus according to a first aspect is an analysis apparatus for analyzing a behavior of a ball that has a center of gravity and in which an acceleration sensor is installed at a position shifted from the center of gravity by a predetermined shift amount, the analysis apparatus including a control unit configured to derive a centrifugal acceleration that is applied to the acceleration sensor, based on acceleration data that is output by the acceleration sensor, and derive at least one of a direction of a rotation axis and a rotation speed of a spin of the ball, based on the predetermined shift amount and the centrifugal acceleration.

The analysis apparatus according to a second aspect is the analysis apparatus according to the first aspect, in which the control unit derives the direction of the rotation axis and a direction of a gravitational acceleration that is applied to the acceleration sensor, based on the acceleration data when the ball is rolling along a ground, derives an inclination of the rotation axis with respect to a horizontal plane, based on the direction of the gravity acceleration and the direction of the rotation axis, and specifies a direction in which the ball curves with respect to a traveling direction in accordance with the inclination of the rotation axis.

The analysis apparatus according to a third aspect is the analysis apparatus according to the first or second aspect, in which the control unit derives a direction of the gravity acceleration that is applied to the acceleration sensor in a state where the ball is stationary, based on the acceleration data in the stationary state, derives a direction of the rotation axis immediately after impact with the ball, based on the acceleration data immediately after impact after the stationary state, and derives an inclination of the rotation axis with respect to the horizontal plane immediately after impact, based on the direction of the gravity acceleration in the stationary state and the direction of the rotation axis immediately after impact.

An analysis method according to a fourth aspect is an analysis method for analyzing a behavior of a ball that has a center of gravity and in which an acceleration sensor is installed at a position shifted from the center of gravity by a predetermined shift amount, and the method includes the following:
deriving a centrifugal acceleration that is applied to the acceleration sensor based on acceleration data that is output by the acceleration sensor
deriving at least one of a direction of a rotation axis and a rotation speed of a spin of the ball, based on the predetermined shift amount and the centrifugal acceleration.

An analysis program according to a fifth aspect is an analysis program for analyzing a behavior of a ball that has a center of gravity and in which an acceleration sensor is installed at a position shifted from the center of gravity by a predetermined shift amount, and the program causes a computer to execute the following:
deriving a centrifugal acceleration that is applied to the acceleration sensor, based on acceleration data that is output by the acceleration sensor
deriving at least one of a direction of a rotation axis and a rotation speed of a spin of the ball, based on the predetermined shift amount and the centrifugal acceleration.

A golf ball according to a sixth aspect includes a center of gravity; and an acceleration sensor installed at a position shifted from the center of gravity by at least 1 mm.

A measuring method according to a seventh aspect is a measurement method for measuring a position of an acceleration sensor installed in a ball, and the method includes the following:
preparing the ball
determining a direction of a measurement axis of the acceleration sensor based on acceleration data that is output by the acceleration sensor in a state where the ball is stationary
deriving a centrifugal acceleration that is applied to the acceleration sensor based on acceleration data that is output by the acceleration sensor when the ball is rotated around an axis that is parallel with the measurement axis and that passes through the center of gravity, at a predetermined rotation frequency
deriving a shift amount of the position of the acceleration sensor from the center of gravity, based on the rotation frequency and the centrifugal acceleration.

An analysis apparatus according to an eighth aspect is an analysis apparatus for analyzing a behavior of a ball in which an acceleration sensor is installed, the analysis apparatus including a control unit configured to derive a direction of a gravitational acceleration applied to the acceleration sensor, based on acceleration data output by the acceleration sensor in a state where the ball is stationary, and derive an elevation angle of the ball, based on the direction of the gravitational acceleration and the acceleration data output by the acceleration sensor at impact with the ball after the stationary state where the ball is stationary.

An analysis apparatus according to a ninth aspect is the analysis apparatus according to the eighth aspect, in which the control unit derives a ratio between axial directions of the acceleration applied to the acceleration sensor, based on the acceleration data at impact, and estimates the acceleration at impact based on the ratio, and derives the elevation angle based on the direction of the gravity acceleration and the estimated acceleration.

An analysis apparatus according to a tenth aspect is an analysis apparatus for analyzing a behavior of a ball in which an acceleration sensor is installed, the analysis apparatus including a control unit configured to derive an initial speed of the ball based on acceleration data output by the acceleration sensor at impact with the ball.

A ball according to an eleventh aspect includes a ball main body, an electrical element embedded in the ball main body, and at least one of a weight and a gap arranged in the ball main body such that values of first, second, and third main inertia moments are approximated to each other.

If the position of the acceleration sensor installed in the ball is shifted from the center of gravity of the ball, a centrifugal acceleration is applied to the acceleration sensor while the ball is rotating. In this regard, according to the analysis apparatus, method, and program according to the first to fifth aspects, a ball is used in which the position of the acceleration sensor is shifted from the center of gravity of the ball, and the shift amount is known. As a result, the centrifugal acceleration applied to the acceleration sensor can be measured, and at least one of the direction of the rotation axis and the rotation speed of the spin of the ball is derived based on the measured centrifugal acceleration and the known shift amount. Accordingly, an analysis apparatus, method, and program that are suitable for analyzing the behavior of a ball are provided.

According to the sixth aspect, a golf ball in which the acceleration sensor is installed at the position shifted from the center of gravity by at least 1 mm is provided. In this manner, the centrifugal acceleration applied to the acceleration sensor can be measured, and various parameters can be derived based on the centrifugal acceleration. Accordingly, a ball that is suitable for analyzing the behavior thereof is provided.

With the measurement method according to the seventh aspect, the position of the acceleration sensor installed in the ball can be measured.

With the analysis apparatus according to the eighth and the ninth aspects, the elevation angle of the ball can be derived. With the analysis apparatus according to the tenth aspect, the initial speed of the ball at impact can be derived. Accordingly, an analysis apparatus that is suitable for analyzing the behavior of the ball is provided.

According to the eleventh aspect, the values of the three main inertia moments can be approximated to each other by at least one of the weight and the gap arranged in the ball main body. Accordingly, a ball whose rotation axis can be stabilized can be provided.

### BRIEF DESCRIPTION OF THE DRAWINGS

FIG. 1 is a diagram showing an overall configuration of an analysis system including a ball and an analysis apparatus according to an embodiment of the present invention.

FIG. 2 is a functional block diagram showing an electrical configuration of a measurement unit included in the ball.

FIG. 3 is a functional block diagram showing an electrical configuration of the analysis apparatus.

FIG. 4 is a diagram showing a dynamic model in a ball coordinate system.

FIG. 5A is a graph showing a waveform of acceleration data output by an acceleration sensor while the ball is rolling along a ground.

FIG. 5B is a graph showing a waveform of acceleration data output by an acceleration sensor while the ball is in flight.

FIG. 6A is a diagram showing a dynamic model when the ball rolling along the ground is seen from the side with respect to a traveling direction.

FIG. 6B is a diagram showing a dynamic model when the ball rolling along the ground is seen from behind with respect to the traveling direction.

FIG. 7A shows graphs of components of x, y, and z axis directions of an acceleration at impact.

FIG. 7B shows graphs of the components of the x, y, and z axis directions of acceleration in a case where range-over has occurred at impact.

FIG. 8 is a diagram showing the dynamic model when the ball at impact is seen from the side with respect to the traveling direction.

FIG. 9 is a flowchart showing a flow of a measurement method according to the embodiment of the present invention.

FIG. 10 is a diagram showing a measurement apparatus used for implementing the measurement method.

FIG. 11A shows graphs of centrifugal acceleration with respect to a square of an angular velocity of the ball.

FIG. 11B shows graphs of centrifugal acceleration with respect to a square of an angular velocity of the ball.

FIG. 11C shows graphs of centrifugal acceleration with respect to a square of an angular velocity of the ball.

FIG. 12 is a graph showing a working example of the present invention.

### DETAILED DESCRIPTION OF THE PREFERRED EMBODIMENTS

Hereinafter, an analysis apparatus, method, and program, a ball, and a measurement method according to an embodiment of the present invention will be described with reference to the drawings.

### 1. Outline of Analysis System

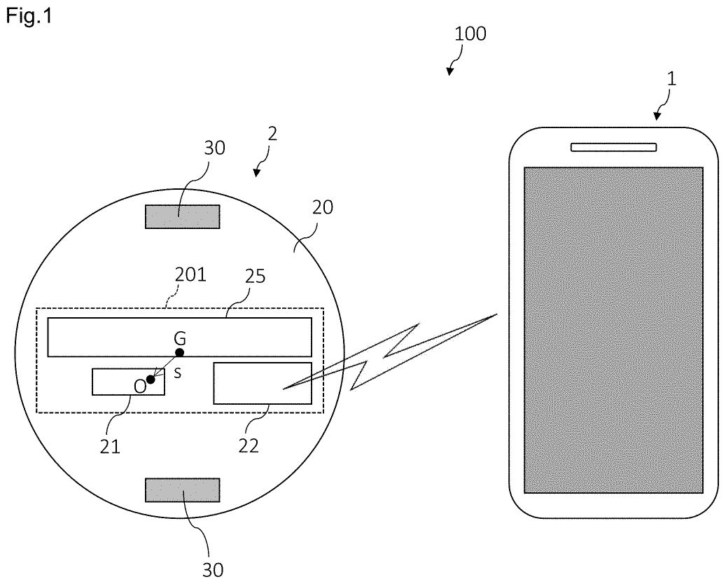

FIG. 1 is a diagram showing an overall configuration of an analysis system 100 including a ball 2 and an analysis apparatus 1 according to the present embodiment. The analysis apparatus 1 is an apparatus for analyzing the behavior of the ball 2. As shown in FIG. 1, an acceleration sensor 21 and a communication device 22 are installed in the ball 2. The analysis apparatus 1 receives acceleration data that is output by the acceleration sensor 21 via the communication device 22, and analyzes the behavior of the ball 2 based on this acceleration data. Hereinafter, after describing the configurations of the ball 2 and the analysis apparatus 1, processing for analyzing the behavior of the ball 2, and a method for measuring a position of the acceleration sensor 21 installed in the ball 2 will be described.

### 2. Configuration of Units

### 2-1. Configuration of Ball

The ball 2 according to the present embodiment is a golf ball, and as shown in FIG. 1, includes a spherical ball main body 20. The ball main body 20 is typically formed by one or a plurality of materials such as a synthetic rubber or a synthetic resin.

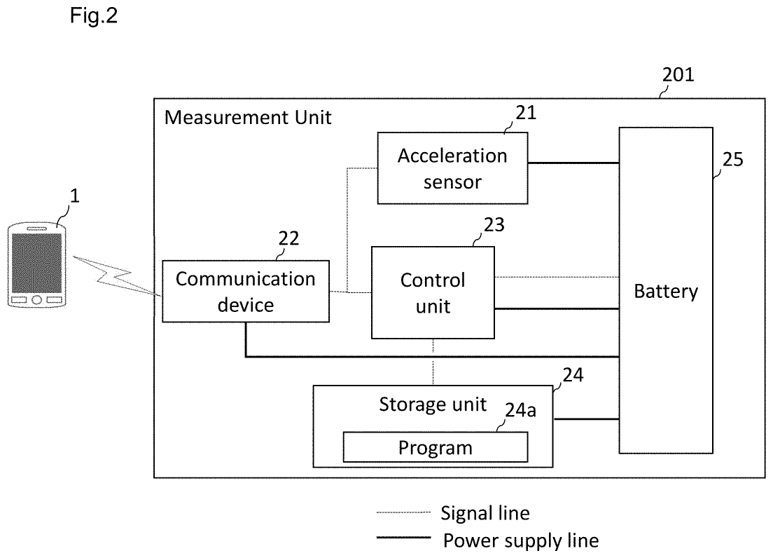

A measurement unit 201 is embedded inside the ball main body 20. FIG. 2 is a functional block diagram showing an electrical configuration of the measurement unit 201. As shown in FIG. 2, the measurement unit 201 includes, in addition to the above acceleration sensor 21 and the communication device 22, various electrical elements such as a control unit 23, a storage unit 24, a battery 25, and one or a plurality of circuit boards (not shown) on which these elements 21 to 25 are mounted. Note that, although various electrical elements are installed in the ball 2, the arrangement of these electrical elements are well-designed, and a center of gravity G of the ball 2 is located near a geometric center of the ball 2. When the radius of the ball 2 is denoted by L and the distance between the center of gravity G of the ball 2 and the geometric center of the ball 2 is denoted by l, preferably l/L≤0.01, and more preferably l/L≤0.005. When the ball 2 is a golf ball, preferably l≤0.5 mm, more preferably l≤0.4 mm, even more preferably l≤0.3 mm, and further more preferably l≤0.2 mm.

The acceleration sensor 21 according to the present embodiment is a triaxial acceleration sensor, and includes three measurement axes, namely, an x axis, a y axis, and a z axis, which are orthogonal to each other, and can measure the accelerations in the x, y, and z directions. The acceleration sensor 21 can, however, also be configured to be capable of measuring the accelerations in the x, y, and z directions by combining the three separate single-axis acceleration sensors. Note that, from the viewpoint of ensuring the accuracy of measurement of parameters, which will be described later, when the gravitational acceleration is denoted by g and the measurement range of the acceleration sensor 21 is denoted by −R to R, preferably R≥16 g. Also, although not limited to this, typically R≤6000 g, and more typically R≤2000 g.

The acceleration sensor 21 is arranged at a position that is shifted from the center of gravity G of the ball 2 by a predetermined shift amount s. Note that the shift amount s mentioned here may be the distance from the center of gravity G of the ball 2 to the origin O of the measurement axis of the acceleration sensor 21, and is measured by a measurement method that will be described later. Although described later in detail, since the position of the acceleration sensor 21 is shifted from the center of gravity G of the ball 2, a centrifugal acceleration α is applied to the acceleration sensor 21 while the ball 2 is rotating.

The communication device 22 is a communication interface that enables communication with an external device. In the present embodiment, the communication device 22 is compliant with a standard of contactless communication or short-range wireless communication, and enables wireless communication with an external device that is also compliant with the same standard. The communication device 22 wirelessly transmits acceleration data output by the acceleration sensor 21 to the analysis apparatus 1 serving as the external device. Note that, the communication device 22 may also be connected to the analysis apparatus 1 by cable.

The control unit 23 is constituted by a CPU, a ROM, a RAM, and the like, and controls the operations of the acceleration sensor 21, the communication device 22, the storage unit 24, and the battery 25. The storage unit 24 is constituted by a nonvolatile rewritable storage device such as a flash memory, and stores (or temporarily saves) various types of data including the acceleration data output by the acceleration sensor 21. The storage unit 24 stores a program 24a, and operations which will be described later are performed by the CPU of the control unit 23 reading out and executing the program 24a. Note that, the program 24a may also be stored in the ROM of the control unit 23 instead of the storage unit 24, or may also be distributed to and stored in both. The battery 25 is a power supply for supplying power to the acceleration sensor 21, the communication device 22, the control unit 23, and the storage unit 24.

Incidentally, the case where the main inertia moments I₁, I₂, and I₃ of the ball do not match and I₁>I₂>I₃ will be considered. In this case, due to the tennis racket theorem, the rotations around a first inertia main axis and a third inertia main axis respectively corresponding to I₁ and I₃ are stable, and the rotational axes do not change very much even over time. However, the rotation around a second inertia main axis corresponding to I₂ is unstable and the rotation axis changes over time. On the other hand, if I₁=I₂=I₃, the inertia moments around any axis that passes through the center of gravity G match, and the rotation of the ball is stable.

In this regard, in the ball 2 according to the present embodiment, a weight 30 is arranged inside the ball main body 20 (see FIG. 1) such that the values of the first, second, and third main inertia moments I₁, I₂, and I₃ are approximated to each other. In other words, due to the presence of the weight 30, the values of the inertia moments I₁, I₂, and I₃ are approximated to each other compared to a case where the same material as the ball main body 20 is filled in the space occupied by the weight 30 at the same density. Quantitatively, preferably I₃/I₁≥0.985, more preferably I₃/I₁≥0.990, and even more preferably I₃/I₁≥0.995. Accordingly, although various electrical elements are arranged at locations asymmetric with respect to the center of gravity G in the ball 2, the values of I₁, I₂, and I₃ do not significantly shift from each other. For this reason, the rotation of the ball can be stabilized. Note that, instead of or in addition to the weight 30, the values of I₁, I₂, and I₃ may also be approximated to each other by forming a gap in an appropriate position in the ball main body 20. Note that, the density of the weight 30 may also be less than the density of the ball main body 20.

### 2-2. Configuration of Analysis Apparatus

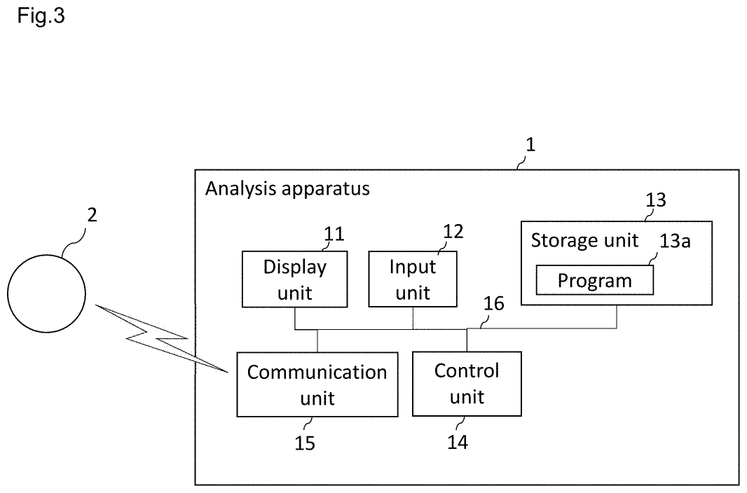

A functional block diagram showing an electrical configuration of the analysis apparatus 1 is shown in FIG. 3. The analysis apparatus 1 is a general-purpose computer in terms of hardware, and is configured by installing a program 13a on the computer. The program 13a is typically provided to the analysis apparatus 1 from an external apparatus via the internet or a network such as using contactless communication or short-range wireless communication network as described above, or from a storage medium such as a CD-ROM. The analysis apparatus 1 according to the present embodiment is a mobile terminal such as a smartphone, a tablet computer, a laptop computer, or an AR (Augmented Reality) terminal such as smart glasses, is carried by a user (in the present embodiment, a golfer), and is brought to various places such as a golf course or a golf practice range. Note that the analysis apparatus 1 can also be realized as a non-mobile computer such as a desktop computer or a server computer.

As shown in FIG. 3, the analysis apparatus 1 includes a display unit 11, an input unit 12, a storage unit 13, a control unit 14, and a communication unit 15. These units 11 to 15 are connected to each other via a bus line 16, and can communicate with each other. In the present embodiment, the display unit 11 is formed by a liquid crystal display or the like, and displays necessary information to a user. The input unit 12 is formed by a touch panel, operation buttons, a mouse, a keyboard, and the like, and accepts operations on the analysis apparatus 1 by the user.

The storage unit 13 is formed by a nonvolatile storage device such as a flash memory or a hard disk, and stores the program 13a. The control unit 14 is formed by a CPU, a ROM, a RAM and the like. The control unit 14 executes processing which will be described later, by reading out and executing the program 13a in the storage unit 13.

The communication unit 15 is a communication interface that enables communication with an external device. In the present embodiment, the communication unit 15 is compliant with a standard of contactless communication or short-range wireless communication as described above, and enables wireless communication with an external device that are also compliant with the same standard. The communication unit 15 wirelessly receives the acceleration data output by the acceleration sensor 21 in the ball 2 serving as the external device. Note that, the communication unit 15 may also be connected to the ball 2 by cable.

### 3. Analysis Processing of Behavior of Ball

Next, analysis processing for analyzing the behavior of the ball 2 will be described. Specifically, while a power supply (battery) 25 of the measurement unit 201 of the ball 2 is set to ON, the acceleration sensor 21 measures the accelerations in the x, y, and z directions at predetermined short time intervals, and obtains the acceleration data. Note that, ON/OFF (including power-saving mode) of the power supply (battery) 25 can be switched in a contactless manner as described in JP 2019-15531A and JP 2019-181026A, for example. The acceleration data obtained by the acceleration sensor 21 is transmitted to the analysis apparatus 1 via the communication device 22 in real time. On the analysis apparatus 1 side, the communication unit 15 receives the acceleration data, and the control unit 14 analyzes the behavior of the ball 2 based on the acceleration data. Hereinafter, items that represent the behavior of the ball 2 and are derived by the control unit 14 will be described.

### 3-1. Direction of Rotation Axis and Rotation Speed of Spin

When the ball 2 is hit by a golf club, the ball 2 flies through the air or rolls along the ground. At this time, spin is generated on the ball 2. In the present embodiment, the direction of the rotational axis and a rotation speed n of the spin of the ball 2 are derived as parameters representing the behavior of the ball 2.

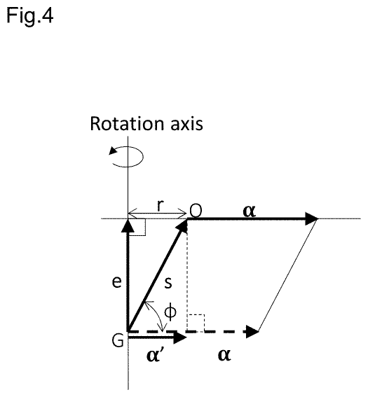

Since the spin of the ball 2 typically occurs around the rotational axis that passes through the center of gravity G of the ball 2, a centrifugal force due to the spin does not occur in the center of gravity G. However, as described above, since the acceleration sensor 21 is located at a position shifted from the center of gravity G, a centrifugal acceleration α is applied to the acceleration sensor 21, and the acceleration sensor 21 detects the centrifugal acceleration α. FIG. 4 shows a dynamic model in a coordinate system fixed to the ball 2 (hereinafter called a “ball coordinate system”). The ball coordinate system is a coordinate system in which the center of gravity G of the ball 2 is set as the origin, and coordinate axes that are respectively parallel with the x axis, the y axis, and the z axis that are the measurement axes of the acceleration sensor 21 are provided.

As shown in FIG. 4, in the ball coordinate system, the centrifugal acceleration α is applied to the position of an origin O on the measurement axis of the acceleration sensor 21 that is shifted from the center of gravity G by the shift amount s. The centrifugal acceleration α is orthogonal to the rotational axis of spin. Hereinafter, the shift amount s may be represented as a vector that is directed to the origin O from the center of gravity G, as shown in FIG. 4. A vector e in FIG. 4 is a vector (hereinafter also called a “rotation axis direction vector”) that is parallel with the rotational axis of spin and has the same magnitude as a component of the rotational axis direction of the vector s. A vector α′ in FIG. 4 is a vector (hereinafter also called a “centrifugal acceleration vector α”) that is parallel with a vector representing the centrifugal acceleration α and has the same magnitude as a component of the direction of the centrifugal acceleration vector α of the vector s. Furthermore, the angle formed by the vector α′ and the vector s is denoted by ϕ. At this time, the equation below is satisfied. Note that, all the vectors α, α′, s, and e in the following equation are vectors in the ball coordinate system.

$$e = s - {α}^{′} = s - \vert s \vert cos φ \frac{α}{\vert α \vert} = s - \frac{s \cdot α}{{\vert α \vert}^{2}} α \qquad [ Equation 1 ]$$

As seen from the above equation, if the vector s and a are found, the rotation axis direction vector e can be derived, and the direction of the rotation axis of spin can be specified. In the present embodiment, the vector s representing the shift amount of the position of the acceleration sensor 21 from the center of gravity G of the ball 2 is known and stored in the storage unit 13. Accordingly, the control unit 14 obtains the vector s by referencing the storage unit 13.

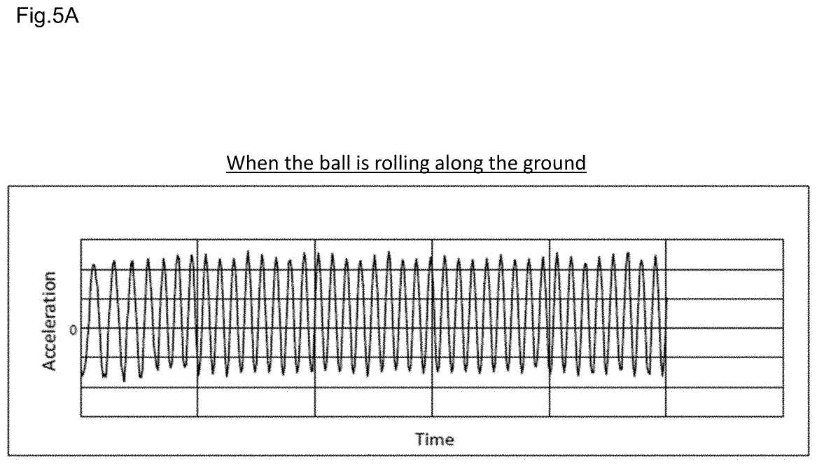

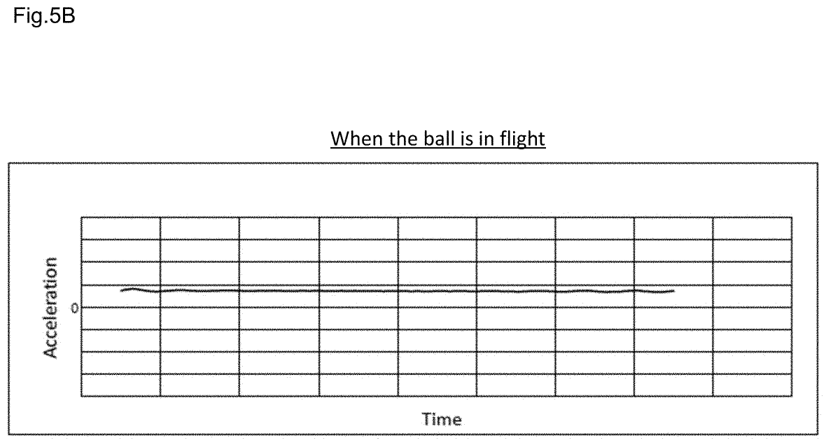

On the other hand, the centrifugal acceleration vector α is obtained based on the acceleration data output by the acceleration sensor 21. Here, FIG. 5A shows a waveform of the acceleration data output by the acceleration sensor 21 when the ball 2 rolls along the ground. When the ball 2 rolls along the ground, the synthetic acceleration of the gravitational acceleration g and the centrifugal acceleration α is mainly applied to the acceleration sensor 21. At this time, a force for stopping the rotation (rolling) acts on the ball 2 from the ground, and the rotation speed n of the ball 2 gradually decreases. However, for a short time period, the rotation speed n of the ball 2 can be regarded as being substantially constant, and the centrifugal acceleration α (=rω²) can also be regarded as being substantially constant. r denotes the distance (rotation radius of the acceleration sensor 21) from the rotation axis of the ball 2 to the origin O of the measurement axis of the acceleration sensor 21, and co denotes the angular velocity (2πm) around the rotation axis of the ball 2. On the other hand, the gravitational acceleration g in the ball coordinate system that is applied to the origin O oscillates with the rotation of the ball 2. Accordingly, the vertical fluctuation of the waveform of the acceleration data shown in FIG. 5A represents the oscillation of the gravitational acceleration g in the ball coordinate system that is applied to the origin O, and the center of the amplitude of the waveform represents the centrifugal acceleration α. As such, when the centrifugal acceleration α is offset from the waveform, the waveform of the gravitational acceleration g in the ball coordinate system that is applied to the origin O appears.

Also, FIG. 5B is an example of the waveform of the acceleration data output by the acceleration sensor 21 while the ball 2 is in flight. The ball 2 in flight is free-falling, and at this time, the acceleration sensor 21 cannot detect gravity, and thus the acceleration sensor 21 mainly detects only the centrifugal acceleration α due to the spin of the ball 2. Accordingly, the waveform of the acceleration data shown in FIG. 5B represents the centrifugal acceleration α. Note that, slight fluctuations due to the air resistance and the like appear in the waveform.

As described above, the control unit 14 derives the center of the amplitude, that is, the centrifugal acceleration vector α, by averaging the acceleration data output by the acceleration sensor 21 in a predetermined short time period. Consequently, the control unit 14 derives the vector e by substituting a known vector s and the centrifugal acceleration vector α into Equation 1, and derives the direction of the rotation axis of the spin of the ball 2 in the ball coordinate system, based on the vector e.

Next, since α=rω², the angular velocity co around the rotation axis of the ball 2 is derived as follows.

$$ω = {( α / r )}^{1 / 2} = {( \frac{α}{\vert s \vert cos φ} )}^{1 / 2} = {( \frac{{\vert α \vert}^{2}}{s \cdot α} )}^{1 / 2} \qquad [ Equation 2 ]$$

As seen from the above equation, if the vectors s and a are known, the angular velocity ω, and hence, the rotation speed n (=ω/2π) can also be derived. Accordingly, the control unit 14 derives the angular velocity co around the rotation axis and the rotation speed n of the ball 2 in the ball coordinate system by substituting a known vector s and the centrifugal acceleration vector α into Equation 2. Note that, since the angular velocity ω and the rotation speed n are exchangeable for each other, they are substantially equivalent parameters.

As described above, the direction of the rotation axis and the rotation speed n of the ball 2 in the ball coordinate system can be derived as long as the ball 2 is rotating, while the ball 2 is in flight or while the ball 2 is rolling along the ground. Accordingly, it is possible to derive the temporal change in the direction of the rotation axis and the rotation speed n of the ball 2 in the ball coordinate system in the time period from when the ball 2 is hit by various types of golf clubs such as a driver, an iron, and a putter and starts to rotate to when the ball stops, and it is also possible to derive the direction of the rotation axis and the rotation speed n of the ball 2 at an arbitrary time in that time period.

As described above, in the present embodiment, the direction of the rotation axis and the rotation speed n of the ball 2 in the ball coordinate system are derived based on the centrifugal acceleration α and the shift amount s. Note that, while the ball 2 is rolling along the ground, the control unit 14 may derive the gravitational acceleration g in the ball coordinate system based on the acceleration data output by the acceleration sensor 21, and further derive the direction of the rotation axis of the ball 2 in the whole coordinate system (with respect to the earth) based on the direction of the gravitational acceleration g in the ball coordinate system and the direction of the rotation axis of the ball 2 in the ball coordinate system. From the viewpoint of ensuring the accuracy of measurement of these parameters, it is preferable that the components of the x, y, and z directions, that constitute the vector s, are greater than 0 mm. Furthermore, when the radius of the ball 2 is denoted as L, preferably 0.05≤|s|/L. If the ball 2 is a golf ball, preferably 1 mm≤|s|. Furthermore, it is more preferable that these numerical conditions are satisfied not only for |si, but also for the components of the x, y, and z directions that constitute the vector s. In consideration of the upper limit of |s|, preferably |s|/L≤0.9, and more preferably |s|/L≤0.5. If the ball 2 is a golf ball, preferably |s|≤20 mm, and more preferably |s|≤10 mm.

### 3-2. Traveling Direction of Ball Rolling Along Ground

The traveling direction of the ball 2 rolling along the ground is derived as a parameter representing the behavior of the ball 2.

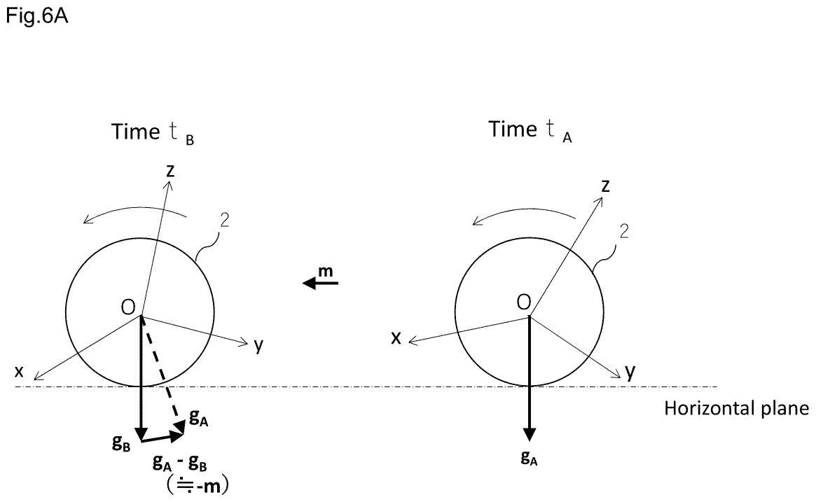

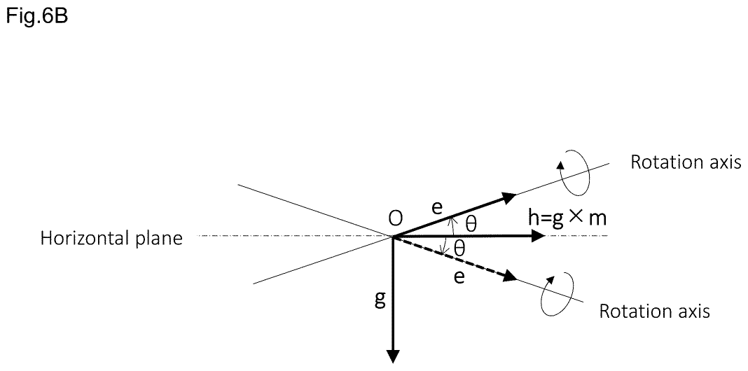

More specifically, the control unit 14 derives the vector (hereinafter, may also be called a “gravitational acceleration vector g”) representing the gravitational acceleration g in the ball coordinate system that is applied to the acceleration sensor 21 at a plurality of the approximate times based on the acceleration data output by the acceleration sensor 21 while the ball 2 is rolling along the ground. Now, a gravitational acceleration vector g at a certain time t_{A} is denoted by g_{A}, and the gravitational acceleration vector g at a time is that is slightly later than the time t_{A} is denoted by g_{B}. At this time, as shown in FIG. 6A, the vector m (hereinafter called a “traveling direction vector”) representing the traveling direction of the ball 2 rolling along the ground is a vector having substantially the same magnitude as and the opposite direction to the change (g_{A}−g_{B}) in the gravitational acceleration vector g. Accordingly, the traveling direction vector m is derived as g_{B}−g_{A}. At this time, as described above, the gravitational acceleration vector g_{A} and g_{B} in the ball coordinate system can be respectively derived by offsetting the centrifugal acceleration α in the ball coordinate system from the acceleration data output by the acceleration sensor 21 at the times t_{A} and t_{B}. In other words, the control unit 14 derives the gravitational acceleration vectors g in the ball coordinate system at the approximated two times. Then, the control unit 14 determines how the gravitational acceleration vector g has changed in the ball coordinate system over time by comparing these gravitational acceleration vectors g with each other, and specifies the traveling direction of the ball 2 based on the comparison result.

As described above, since the traveling direction of the ball 2 is derived based on the gravitational acceleration g, the traveling direction cannot be derived in the time period during the ball 2 is in free fall, such as while the ball 2 is in flight, and the gravitational acceleration g cannot be measured by the acceleration sensor 21, but the traveling direction can be derived in the time period in which the ball 2 is rolling along the ground. Accordingly, it is possible to derive the change over time in the traveling direction of the ball 2 in the time period from when the ball 2 is hit by a putter and the like and starts to roll along the ground to when the ball 2 stops, and derive the traveling direction of the ball 2 at an arbitrary time in that time period as well.

3-3. Inclination of Rotation Axis of Ball Rolling Along Ground and Direction in which Ball Rolling Along Ground Curves

The ball 2 does not always linearly roll along the ground, but in many cases curves to the left or the right while rolling. In the present embodiment, an inclination θ of the rotation axis of the ball 2 rolling along the ground with respect to a horizontal plane and the direction in which the ball 2 rolling along the ground curves with respect to the traveling direction are derived as parameters representing the behavior of the ball 2.

The control unit 14 derives the rotation axis direction vector e, the traveling direction vector m, and the gravitational acceleration vector g by the method that was already described, based on the acceleration data output by the acceleration sensor 21 while the ball 2 is rolling along the ground. Here, FIG. 6B shows a dynamic model of a force that acts on the ball 2 when the ball 2 rolling along the ground is seen from behind with respect to the traveling direction. As shown in FIG. 6B, when considering a vector h (hereinafter called a “horizontal reference vector”) that is perpendicular to the traveling direction vector m and the gravitational acceleration vector g and represents the horizontal direction, h=g×m (outer product of g and m) is satisfied. Since the rotation axis direction vector e and the traveling direction vector m can be regarded as being perpendicular to each other, the vectors g, e, and h exist on the same plane.

The control unit 14 derives the horizontal reference vector h based on the traveling direction vector m and the gravitational acceleration vector g in this manner, and further derives the degree of the inclination θ of the rotation axis of the ball 2 with respect to the horizontal plane based on the rotation axis direction vector e and the horizontal reference vector h according to the equation below.

$$cos θ = \frac{e \cdot h}{\vert e \vert \vert h \vert} \qquad [ Equation 3 ]$$

Next, it is conceivable that the traveling direction of the ball 2 is perpendicular to both the direction of the gravitational acceleration g that acts on the ball 2 and the direction of the rotation axis of the ball 2. Whether the ball 2 curves to the right or left with respect to the traveling direction can be determined from the inclination θ of the rotation axis of the ball 2 with respect to the horizontal plane. More specifically, it is inferred that, when the ball 2 is seen along the traveling direction, if the rotation axis of the ball 2 is inclined in the upper right direction with respect to the horizontal plane, the ball 2 curves to the left with respect to the traveling direction, and if the rotation axis is inclined in the upper left direction, the ball curves to the right with respect to the traveling direction.

Incidentally, although the degree of the inclination θ of the rotation axis can be specified by Equation 3, the sign cannot be specified, and as shown in FIG. 6B, the direction of the inclination θ cannot be determined. In other words, it is not possible to determine whether the inclination θ of the rotation axis is upward or downward with respect to the horizontal plane. As such, the control unit 14 derives two inner products e·h and e·g. Then, if the signs of the two inner products do not match, the control unit 14 determines that the inclination θ is plus and the rotation axis direction vector e is upward with respect to the horizontal plane (the rotation axis is inclined upward to the right with respect to the horizontal plane) and the ball 2 curves to the left with respect to the traveling direction. On the other hand, if the signs of the two inner products match, the control unit 14 determines that the inclination θ is minus and the rotation axis direction vector e is downward with respect to the horizontal plane (the rotation axis is inclined upward to the left with respect to the horizontal plane) and the ball 2 curves to the right with respect to the traveling direction. In other words, the control unit 14 specifies the direction (plus or minus) of the inclination θ of the rotation axis of the ball 2 by comparing the directions of the vectors e, g, and h with each other. Then, according to the direction of the inclination θ (plus or minus), the control unit 14 specifies whether the rotation axis is inclined upward to the right or the left as seen along the traveling direction of the ball 2 thus derived, and according to the direction thus specified, the control unit 14 specifies the direction in which the ball 2 curves with respect to the traveling direction.

As described above, since the inclination θ of the rotation axis and the direction in which the ball 2 curves are derived based on the gravitational acceleration g, the inclination θ and the direction cannot be derived in the time period during the ball 2 is free-falling, such as when the ball 2 is in flight, and the gravitational acceleration g cannot be measured by the acceleration sensor 21. However, in the time period in which the ball 2 is rolling along the ground, the inclination θ and the direction can be derived as long as the ball 2 is rotating. Accordingly, it is possible to derive the change over time in the inclination θ of the rotation axis and the direction in which the ball 2 curves in the time period from when the ball 2 is hit by a putter or the like and the ball 2 starts to roll along the ground to when the ball 2 stops. Alternatively, the direction in which the ball 2 curves at an arbitrary time in that time period can also be derived. Also, the control unit 14 can derive an approximate trajectory of the ball 2 on the ground based on the change over time of the direction in which the ball 2 curves.

### 3-4. Elevation Angle of Ball

An elevation angle (launch angle) ψ of the ball 2 at the time of being hit by a golf club such as when the teed ball 2 is hit by a driver, for example, is derived as a parameter representing the behavior of the ball 2. The elevation angle ψ mentioned here is a launch angle of the ball 2 with respect to the horizontal plane.

First, the control unit 14 derives the direction of the gravitational acceleration g in the ball coordinate system that is applied to the acceleration sensor 21 in the state where the ball 2 is static, by the method which was already described, based on the acceleration data output by the acceleration sensor 21 in the static state where the ball 2 is static. That the ball 2 is in the static state can be determined from the fact that the magnitude of the acceleration detected by the acceleration sensor 21 is substantially 1 g, for example. Next, the control unit 14 determines whether the ball 2 has been hit based on the acceleration data output by the acceleration sensor 21. That the ball 2 has been hit can be determined from the fact that the magnitude of the acceleration detected by the acceleration sensor 21 reaches a predetermined threshold or more after the static state, for example.

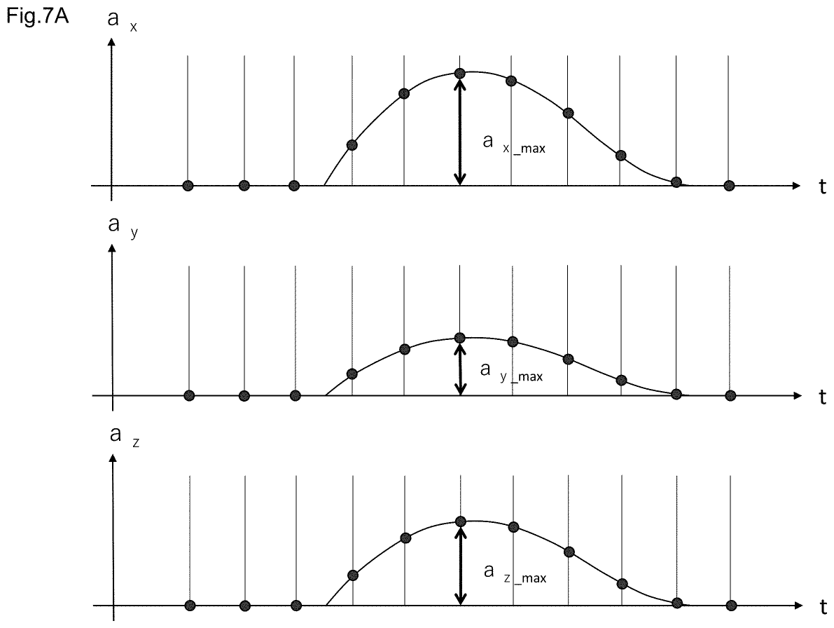

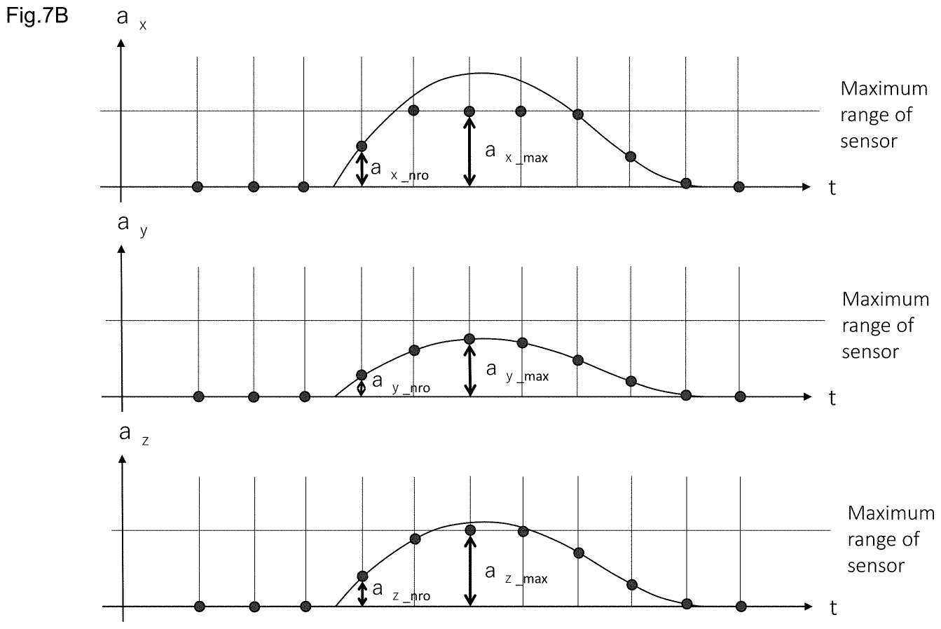

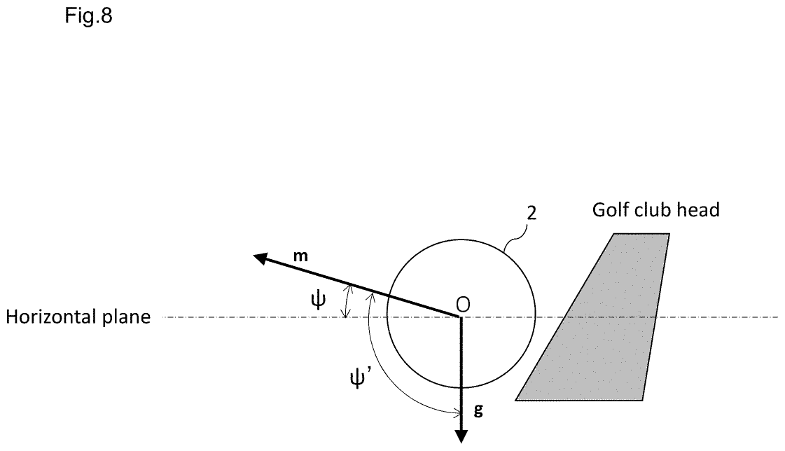

Upon determining that the ball 2 has been hit after the static state, the control unit 14 derives the acceleration α in the ball coordinate system applied to the acceleration sensor 21 at impact, based on the acceleration data that was output by the acceleration sensor 21 at impact. FIG. 7A shows graphs (conceptual diagrams) of the components aₓ, a_{y}, and aₓ of the x, y, and z directions, respectively of the acceleration a. Next, the control unit 14 derives the ratios between the maximum values a_{x_max}, a_{y_max}, and a_{z_max} of the components aₓ, a_{y}, and aₓ, respectively. Then, the control unit 14 estimates the traveling direction vector m representing the traveling direction of the ball 2 at impact based on the ratio (see FIG. 8). Specifically, the values of the x, y, and z components of the traveling direction vector m in the ball coordinate system are derived such that the ratios of the values of the components match the ratio between the above maximum value a_{x_max}, a_{y_max}, and a_{z_max}. At this time, the magnitude of the traveling direction vector m is preferably normalized to be a predetermined value (e.g., 1). Note that, as shown in FIG. 7A, the graphs of the accelerations aₓ, a_{y}, and a_{z} in the x axis, y axis, and z axis directions have generally similar shapes, and take their maximum values at substantially the same time. Accordingly, the traveling direction vector m need not necessarily be derived from the ratio between the maximum values of the components aₓ, a_{y}, and a_{z} of the three axis directions of the acceleration a. For example, the traveling direction vector m can be derived from the ratios of the components aₓ, a_{y}, and a_{z} of the three axis directions at a certain same time (measurement of the axis directions may not always be performed at the exact same time, and in this case, this same time may include times that can be regarded as being substantially the same, such as times that are closest to each other. The same hold true in the next paragraph).

Incidentally, at the time of hitting the ball 2 with the golf club, a considerably large impact is applied to the ball 2, and therefore there are cases in which an acceleration that exceeds the measurement range is applied to the acceleration sensor 21 (hereinafter called “range-over”). FIG. 7B shows graphs (conceptual diagrams) of the components aₓ, a_{y}, and a_{z} of the three axis directions of the acceleration α in the case where range-over has occurred. In this case, the acceleration sensor 21 cannot accurately measure the acceleration. Accordingly, the control unit 14 determines whether range-over has occurred based on the acceleration data that was output by the acceleration sensor 21 at impact with the ball 2. If range-over has occurred, the control unit 14 specifies a certain time when range-over has not occurred for each the component aₓ, a_{y}, and a_{z}, and derives the traveling direction vector m from the ratio between the components a_{z_nro}, a_{y_nro}, and a_{z_nro} of the x, y, and z axis directions of the acceleration a at that time. It is possible to determine that range-over has occurred from the fact that the magnitude of the acceleration a detected by the acceleration sensor 21 has scaled out at the maximum value of the measurement range, for example. In this manner, in both cases where range-over has occurred and where range-over has not occurred, the acceleration a in the ball coordinate system that was applied to the ball 2 at impact can be derived.

Next, the control unit 14 derives the elevation angle ψ of the ball 2 based on the direction of the gravitational acceleration g in the ball coordinate system in the static state, and the acceleration a in the ball coordinate system that was applied to the ball 2 at impact. Specifically, the control unit 14 derives the elevation angle ψ according to the equation below (see FIG. 8).

$$cos {ψ}^{′} = \frac{g \cdot m}{\vert g \vert \vert m \vert} \\ ψ = {ψ}^{′} - 90 ° \qquad [ Equation 4 ]$$

In other words, the traveling direction vector m representing the flight direction of the ball 2 in the ball coordinate system is derived based on the direction of the acceleration a at impact. Then, the elevation angle ψ of the ball 2 at the time of hitting is derived by comparing the traveling direction vector m with the direction of the gravitational acceleration g in the static state.

3-5. Inclination of Rotation Axis of Ball Immediately after Impact

An inclination θ of the rotation axis of the ball 2 with respect to the horizontal plane immediately after impact with the golf club such as when the teed ball 2 is hit by a driver, for example, is derived as a parameter representing the behavior of the ball 2. This inclination θ is calculated similarly to the inclination θ of the rotation axis of the ball 2 rolling along the ground with respect to the horizontal plane, which was described in section 3-3. Note that, the traveling direction vector m used for calculating the inclination θ is derived by the method described in the section 3-4.

Also, if the inclination θ of the rotation axis of the ball 2 with respect to the horizontal plane immediately after impact is known, it is possible to determine the state of (the) spin of the ball 2 immediately after impact, or more specifically, the aspect of backspin and sidespin applied to the ball 2. For example, if θ=0, it is possible to determine that no sidespin is applied.

### 3-6. Initial Speed of Ball

The initial speed of the ball 2 at impact with a golf club such as when the teed ball 2 is hit by a driver, for example, is derived as a parameter representing the behavior of the ball 2.

The control unit 14 derives the initial speed of the ball 2 based on the acceleration data output by the acceleration sensor 21 at impact with the ball 2. More specifically, the control unit 14 derives a time-series magnitude of the acceleration a in the ball coordinate system that is applied to the acceleration sensor 21 at impact, and derives the initial speed of the ball 2 by integrating the magnitude. Rectangular integration, trapezoidal integration or the like can be adopted as the integration performed at this time.

Note that, as already described above, since range-over may occur at impact with a golf club by, the acceleration sensor 21 often cannot accurately measure the acceleration a. Accordingly, the control unit 14 determines whether (a) range-over has occurred based on the acceleration data output by the acceleration sensor 21 at impact. Then, even if (a) range-over has occurred as a whole, in the case where any component of the axis directions of the acceleration α (hereinafter, called “non-range-over component a₁”) has not ranged-over at all at impact, the control unit 14 specifies a specific time when the range-over has not occurred for the components a₂ and a₃ of the remaining two axis directions of the acceleration a, and derives the ratios between the components a₁, a₂, and a₃ of the three axis directions of the acceleration a of the specified time. Next, the control unit 14 estimates portions of the remaining components a₂ and a₃ where the range-over has occurred, based on the derived ratio and the component a₁. Thereafter, the control unit 14 derives the magnitude of the acceleration a based on the components a₂ and a₃ thus specified (the estimated value is adopted to the portions where a range-over has occurred, and the measurement value is adopted to the portions where no range-over has occurred) and the component a₁, and derives the initial speed of the ball 2 by integrating the magnitude thus derived. Rectangular integration, trapezoidal integration or the like can also be adopted as the integration performed at this time.

On the other hand, in the case where range-over has occurred in all the components of the axis directions of the acceleration a, the control unit 14 estimates the initial speed of the ball 2 by referencing the data of the waveform of the magnitude of the acceleration a for which range-over has not occurred, such as the initial period at impact, with predetermined correspondence relationship data. The correspondence relationship data referred to here is data representing a correspondence relationship between the data for the waveform of the magnitude of the acceleration a for which range-over has not occurred and the initial speed of the ball 2, and data prepared in advance based on a multitude of experiments. The experiments referred to here are performed as follows. First, the waveforms of the magnitude of the acceleration a at impact can be considered as having similar shapes as long as there is no significant difference between the characteristics of the golf clubs, such as clubs whose numbers are not widely different. For this reason, when performing the experiments, a ball in which an acceleration sensor having a wide measurement range and for which range-over is not likely to occur is prepared, and the ball is hit with various golf clubs a multitude of times. Then, the patterns of the waveforms of the magnitude of the acceleration a are measured by the acceleration sensor, and also the initial speeds of the ball are calculated based on the measured waveform patterns. After that, using the results of the experiments, data representing the correspondence relationship is prepared by associating the characteristics of the golf clubs (e.g., number), with the initial speed, and the patterns of the waveforms of the magnitude of the acceleration a. When performing measurement, a pattern of the waveform which is most associated with data of the waveform indicating the magnitude of the acceleration α that is not ranged-over is specified, out of data for which the characteristics of the golf clubs match in the data representing the correspondence relationship. Then, the initial speed corresponding to the pattern of the waveform is estimated as the initial speed of the ball 2.

### 3-7. Other Matters

The control unit 14 can further analyze the behavior of the ball 2 based on the various kinds of parameters derived as above. For example, consider a case in which the ball 2 is launched at the time of a shot with a driver, an iron, or the like. At this time, the course of the ball 2 in flight can be derived based on the above parameters appropriately taking the air resistance and the like into consideration. Note that, when analyzing the behavior of the ball 2 in flight, it can be assumed that the direction of the rotation axis of the ball 2 with respect to the earth hardly changes. Also, for example, in the case where the ball 2 rolling along the ground at the time of a shot with a putter or the like as well, the course of the ball 2 can be derived based on the above parameters. At this time, when analyzing the behavior of the ball 2 rolling along the ground, it can be assumed that the ball 2 is not sliding on the ground.

### 4. Method for Measuring Shift Amount of Acceleration Sensor

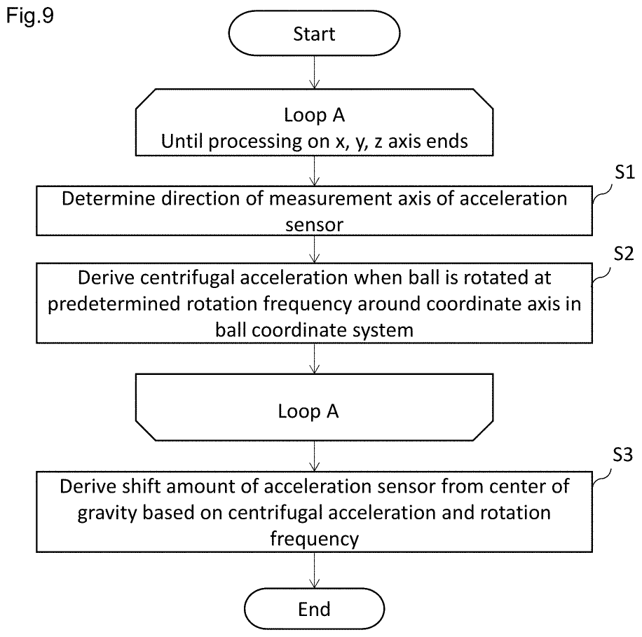

Hereinafter, a measurement method for measuring the position of the acceleration sensor 21 installed inside the ball 2, or more specifically, a shift amount s of the acceleration sensor 21 from the center of gravity G will be described with reference to FIG. 9.

First, the ball 2 is prepared, and the direction of the measurement axis (direction in the ball coordinate system) of the acceleration sensor 21 installed in the ball 2 is measured (step S1). Specifically, the ball 2 is made stationary at various angles with respect to the earth, and the direction of the measurement axis of the acceleration sensor 21 is determined based on the acceleration data that is output by the acceleration sensor 21 in the stationary states. In other words, a state where the measurement value in the x direction is 1 g and the measurement values in the y and z directions are 0 is sought by monitoring the measurement values output by the acceleration sensor 21, and determines the vertical direction in this state as the direction of the x axis constituting the measurement axis. Similarly, the directions of the y and z axes constituting the measurement axis are determined by repeatedly performing step S1.

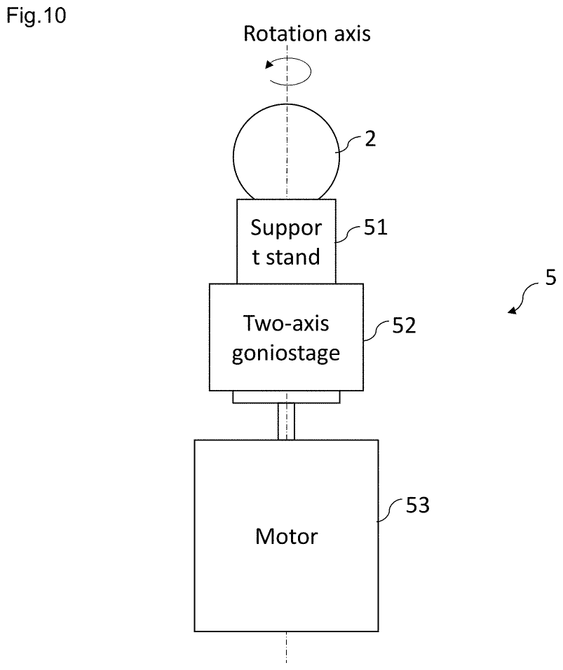

In order to perform this measurement method, a measurement device 5 shown in FIG. 10 can be used. The measurement device 5 includes a two-axis goniostage 52 and a support stand 51 placed on the top plate of the goniostage 52. The support stand 51 is a stand for supporting the ball 2. The two-axis goniostage 52 includes two knobs (not shown). By manually rotating each of the knobs, the inclination angles of two stages of the two-axis goniostage 52 can be adjusted, and accordingly, the orientation of the ball 2 placed on the support stand 51 can be adjusted. Note that, the rotation centers of the two stages of the two-axis goniostage 52 match each other. Furthermore, the support stand 51 and the two-axis goniostage 52 are coaxially arranged, and a geometric center of the ball 2 placed on the support stand 51 matches the rotation center of the two stages of the two-axis goniostage 52. In step S1, the measurement axis is sought by monitoring the measurement values output by the acceleration sensor 21 while adjusting the orientation of the ball 2 by using the two-axis goniostage 52.

In the following step S2, the ball 2 is rotated around the coordinate axes of the ball coordinate system at a predetermined rotation frequency, and the centrifugal accelerations α applied to the acceleration sensor 21 during the rotation are derived. The x, y, and z axes constituting the coordinate axes of the ball coordinate system are axes that are parallel with the x, y, and z axes of the acceleration sensor 21 detected in step S1, and pass through the center of gravity G of the ball 2. In the present embodiment, the ball 2 is rotated at multiple rotation frequencies, and the centrifugal acceleration vector α corresponding to each rotation frequency is derived.

As shown in FIG. 10, the measurement device 5 includes a motor 53 arranged below the two-axis goniostage 52. In step S2, whenever the measurement axes are detected in step S1, the motor 53 is driven at a predetermined rotation frequency without moving the ball 2 on the support stand 51. The rotation axis of the motor 53 is coaxially arranged with the rotation center of the two stages of the two-axis goniostage 52. Accordingly, regardless of the direction of inclination of the two stages of the two-axis goniostage 52, the center of gravity of the ball 2 on the support stand 51 is arranged on the central axis of the motor 53. As such, when the motor 53 is driven, the ball 2 rotates around one coordinate axis constituting the ball coordinate system. Then, the acceleration data output by the acceleration sensor 21 while the motor 53 is driven is obtained, and the centrifugal acceleration vectors α applied to the acceleration sensor 21 are derived by the method that was already described, based on the obtained acceleration data.

As shown in FIG. 9, when step S1 and step S2 are repeatedly executed and the centrifugal acceleration vectors α around the x axis, y axis, and z axis of the ball coordinate system are derived, step S3 is performed. In step S3, a vector s representing the shift amount is derived based on the centrifugal acceleration vectors α derived in step S2 and the rotation speeds of the ball 2 at the time when the centrifugal acceleration vectors α were obtained. The rotation speed of the ball 2 matches the rotation speed of the motor 53.

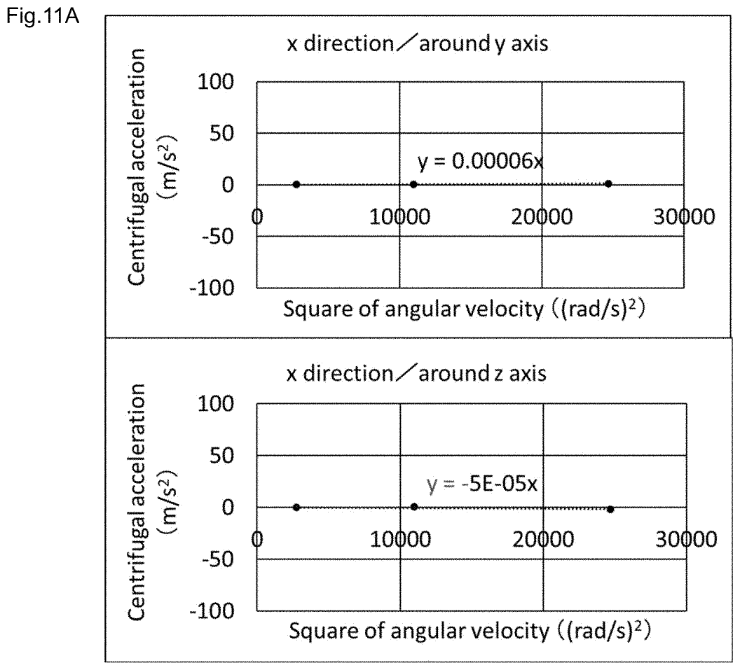

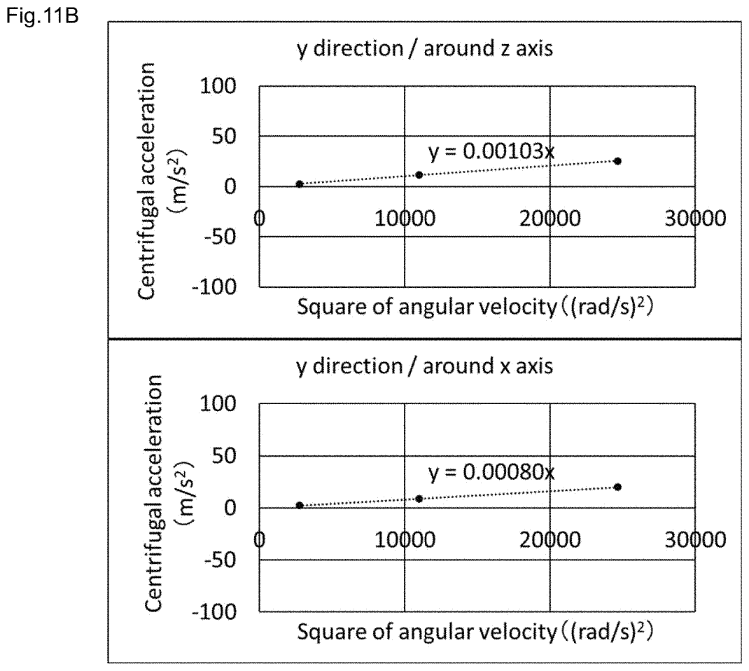

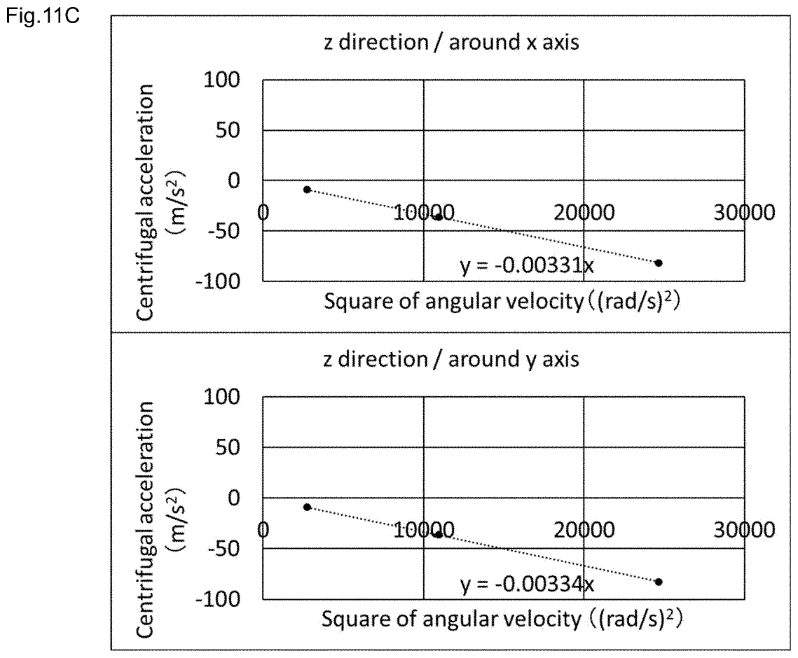

α=rω² is satisfied as the relationship between the rotation radius r of the acceleration sensor 21 and the angular velocity ω of the ball 2. Accordingly, when ω² is represented by the horizontal axis and a is represented by the vertical axis, the relationship between ω^{t} and α is represented by a straight line that passes through the origin and has the inclination r. FIGS. 11A, B and C show graphs of the centrifugal acceleration α when the ball 2 is rotated at 500 rpm, 1000 rpm, and 1500 rpm, in which the horizontal axis represents the square of the angular velocity ω. The six graphs in FIGS. 11A-C illustrate the centrifugal acceleration vectors α in the x direction when the ball 2 is rotated around the y axis and z axis, the centrifugal accelerations α in the y direction when the ball 2 is rotated around the z axis and x axis, and the centrifugal accelerations α in the z direction when the ball 2 is rotated around the x axis and y axis. As shown in FIGS. 11A-C, if the centrifugal acceleration vector α and the rotation speed of the ball 2 are found, the rotation radius r can be derived as the inclination of a with respect to ω² calculated from the rotation speed of the ball 2. Note that, the rotation radius r is the distance from the rotation axis to the origin O of the measurement axis of the acceleration sensor 21. Accordingly, in step S3, the vector s that extends from the center of gravity G serving as the origin of the ball coordinate system toward the origin O of the measurement axis is derived, based on the components of one or two axes directions of the rotation radius r around the three axes. Note that, for example, two values of the shift amount s from the center of gravity in the x axis direction are derived from the centrifugal accelerations α in the x axis direction when the ball 2 is rotated around the y axis and z axis. In this case, these two values may be averaged.

In this manner, the shift amount s of the acceleration sensor 21 from the center of gravity G is measured. The above measurement method can be used for calibration from a design value of the shift amount s in the case where the design value of the shift amount s is known.

### 5. Variations

Although the embodiments of the present invention have been described above, the present invention is not limited to the above embodiments, and various changes can be made without departing from the gist of the invention. For example, modifications as below can be applied. Note that the gist of following variations can be combined as appropriate.

5-1

In addition to the acceleration sensor, at least one selected from a group consisting of a geomagnetic sensor, an angular velocity sensor, a pressure sensor, a temperature sensor, an inclination sensor, and a position measurement sensor (e.g., GPS sensor) may also be installed in the ball 2, or an inertia sensor in which an acceleration sensor, a geomagnetic sensor, and an angular velocity sensor are integrated may also be installed in the ball 2.

Also, a plurality of acceleration sensors may also be mounted. In this case, an acceleration sensor having a wider measurement range (hereinafter, “first acceleration sensor”) can be arranged at a position closer to the center of gravity G. Since an acceleration sensor (hereinafter, “second acceleration sensor”) having a greater shift amount from the center of gravity G than the first acceleration sensor is subjected to a greater centrifugal acceleration in addition to a translational acceleration when the ball 2 is hit with a golf club, the measurement accuracy of the translational acceleration may be deteriorated. As such, the translational acceleration may be measured by the first acceleration sensor that is closer to the center of gravity G and has a wider measurement range, and the centrifugal acceleration and the gravitational acceleration may be measured by the second acceleration sensor for which the shift amount from the center of gravity G is greater than the first acceleration sensor and which has a smaller measurement range and a higher sensitivity than the first acceleration sensor.

5-2

The position of the acceleration sensor need not be shifted from the center of gravity G. In this case as well, for example, the elevation angle and the initial speed of the ball 2 that are derived without using the centrifugal acceleration α can be derived.

5-3

Although the behavior of a golf ball was analyzed in the above embodiments, the present invention can be applied to other kinds of balls such as a baseball ball and a tennis ball.

### Working Example

A ball was prepared in which was installed an inertia sensor unit that had the origin of the measurement axis at a position that is spaced apart from the center of gravity of the ball by 0.0 mm in the x axis direction, 0.9 mm in the y axis direction, and −3.3 mm in the z axis direction. The shift amounts in the axis directions at this time were measured based on the above measurement method, and the values derived from the centrifugal accelerations in the remaining two axis directions were averaged. Then, a test was performed in which the ball was thrown upward three times for each of axes, namely, the x axis, the y axis, the z axis, an xy axis (an axis equally distant from the x and y axes), an yz axis (an axis equally distant from the y and z axes), a zx axis (an axis equally distant from the z and x axes), and an xyz axis (an axis equally distant from the x, y, z axes), such that the ball rotated around each axis. Then, the acceleration data while the ball was being thrown upward was measured by using a three-axis acceleration sensor included in the inertia sensor unit, and the rotation frequency of the ball (converted from the rotation speed) was calculated by a method similar to the above embodiments based on the measured acceleration data. Also, geomagnetic data while the ball was being thrown upward was measured by using the geomagnetic sensor included in the inertia sensor unit. Then, since the geomagnetic data vibrates according to the rotation of the ball, the rotation frequency of the ball was calculated based on the cycle of the vibrations of the geomagnetic data.

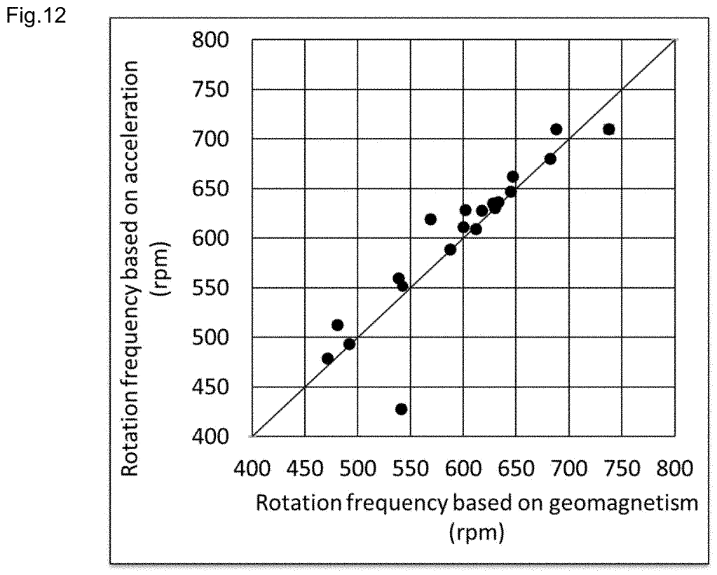

FIG. 12 shows the results of the above measurement. The vertical axis of FIG. 12 represents the rotation frequency of the ball based on the acceleration data, and the horizontal axis represents the rotation frequency of the ball based on the geomagnetic data. A high correlation between the rotation frequency based on the acceleration data and the rotation frequency based on the geomagnetic data is evident in FIG. 12. Accordingly, the validity of the measurement method of the rotation frequency of the ball (rotation speed) based on the acceleration data according to the above embodiments was confirmed. Note that, if there is a metal, a magnet, or the like near the geomagnetic sensor, the geomagnetism is affected by the metal or the like, and thus the rotation frequency based on the geomagnetic data cannot be accurately measured. However, according to the method based on the acceleration data according to the above embodiments, even in the case where there is a metal, a magnet, or the like in the surroundings, it is possible to ensure a measurement accuracy that is similar to the case where the method based on the geomagnetic data was adopted under a condition where there is no metal or magnet in the surroundings.

### LIST OF REFERENCE NUMERALS

| | | |
|---|---|---|
| 100 Analysis system | 1 Analysis apparatus | |
| 13a Program | 14 Control unit | |
| (analysis program) | | |
| 2 Ball | 20 Ball main body | 21 Acceleration sensor |
| 22 Communication | 23 Control unit | |
| device | | |
| 24 Storage unit | 25 Battery | 30 Weight |
| G Center of gravity | O Origin of | |
| of ball | measurement axis | |
| s Shift amount | α Centrifugal | |
| | acceleration vector | |
| e Rotation axis | g Gravitational | |
| direction vector | acceleration | |

What is claimed is:

1. An analysis apparatus for analyzing a behavior of a ball that has a center of gravity and in which an acceleration sensor is installed at a position shifted from the center of gravity by a predetermined shift amount, the analysis apparatus comprising:
a control unit configured to derive a centrifugal acceleration that is applied to the acceleration sensor, based on acceleration data that is output by the acceleration sensor, and derive at least one of a direction of a rotation axis and a rotation speed of a spin of the ball, based on the predetermined shift amount and the centrifugal acceleration.

2. The analysis apparatus according to claim 1,
wherein the control unit derives the direction of the rotation axis and a direction of a gravitational acceleration that is applied to the acceleration sensor based on the acceleration data when the ball is rolling along a ground,
derives an inclination of the rotation axis with respect to a horizontal plane based on the direction of the gravity acceleration and the direction of the rotation axis, and
specifies a direction in which the ball curves with respect to a traveling direction in accordance with the inclination of the rotation axis.

3. The analysis apparatus according to claim 1,
wherein the control unit derives a direction of the gravity acceleration that is applied to the acceleration sensor in a state where the ball is stationary, based on the acceleration data in the stationary state,
derives a direction of the rotation axis immediately after impact with the ball, based on the acceleration data immediately after impact after the stationary state, and
derives an inclination of the rotation axis with respect to the horizontal plane immediately after impact based on the direction of the gravity acceleration in the stationary state and the direction of the rotation axis immediately after impact.

4. The analysis apparatus according to claim 2,
wherein the control unit derives a direction of the gravity acceleration that is applied to the acceleration sensor in a state where the ball is stationary, based on the acceleration data in the stationary state,
derives a direction of the rotation axis immediately after impact with the ball, based on the acceleration data immediately after impact after the stationary state, and
derives an inclination of the rotation axis with respect to the horizontal plane immediately after impact based on the direction of the gravity acceleration in the stationary state and the direction of the rotation axis immediately after impact.

5. An analysis method for analyzing a behavior of a ball that has a center of gravity and in which an acceleration sensor is installed at a position shifted from the center of gravity by a predetermined shift amount, the method comprising:
deriving a centrifugal acceleration that is applied to the acceleration sensor, based on acceleration data that is output by the acceleration sensor, and
deriving at least one of a direction of a rotation axis and a rotation speed of a spin of the ball, based on the predetermined shift amount and the centrifugal acceleration.

6. A non-transitory computer readable medium storing an analysis program for analyzing a behavior of a ball that has a center of gravity and in which an acceleration sensor is installed at a position shifted from the center of gravity by a predetermined shift amount, and the analysis program causing a computer to:
derive a centrifugal acceleration that is applied to the acceleration sensor, based on acceleration data that is output by the acceleration sensor, and
derive at least one of a direction of a rotation axis and a rotation speed of a spin of the ball, based on the predetermined shift amount and the centrifugal acceleration.

7. A golf ball comprising:
a center of gravity; and
an acceleration sensor installed at a position shifted from the center of gravity by at least 1 mm.

8. A measurement method for measuring a position of an acceleration sensor installed in a ball, the method comprising:
preparing the ball;
determining a direction of a measurement axis of the acceleration sensor based on acceleration data that is output by the acceleration sensor in a state where the ball is stationary; and
deriving a centrifugal acceleration that is applied to the acceleration sensor, based on acceleration data that is output by the acceleration sensor when the ball is rotated around an axis that is parallel with the measurement axis and that passes through a center of gravity of the ball, at a predetermined rotation frequency; and
deriving a shift amount of the position of the acceleration sensor from the center of gravity based on the rotation frequency and the centrifugal acceleration.
